(19) United States
(12) Patent Application Publication
(10) Pub. No.: US 2025/0147783 A1
(43) Pub. Date: May 8, 2025

(54) COMPUTER-EXECUTED METHOD, SYSTEM, AND COMPUTER-READABLE STORAGE MEDIUM

(71) Applicant: YANGTZE MEMORY TECHNOLOGIES CO., LTD., Wuhan (CN)

(72) Inventors: Dan Lu, Wuhan (CN); Yi Luo, Wuhan (CN); Yaping Zhang, Wuhan (CN)

(21) Appl. No.: 18/387,764

(22) Filed: Nov. 7, 2023

(51) Int. Cl. G06F 9/455; G06F 9/38

(52) U.S. Cl. CPC G06F 9/45558; G06F 9/3814; G06F 2009/45583

(57) ABSTRACT

According to one aspect of the present disclosure, a computer-executed method is provided. The method may include receiving a first request sent from a first virtual machine. The first virtual machine may be configured to emulate a host. The method may include establishing communication between the first virtual machine and a second virtual machine in response to the first request. The second virtual machine may be configured to emulate a memory system.

### FIELD OF TECHNOLOGY

The present disclosure relates to the field of semiconductor technology, and relates to, but are not limited to, a computer-executed method, system, and computer-readable storage medium.

### BACKGROUND

Semiconductor memory devices may be classified as volatile memory devices (e.g., such as Static Random-Access Memory (SRAM) or Dynamic Random Access Memory (DRAM)) or non-volatile memory devices (e.g., such as flash memory devices, Phase Change Random Access Memory (PCRAM), Magnetoresistive Random Access Memory (MRAM), Resistive Random Access Memory (RRAM) and Ferroelectric Random Access Memory (FRAM), etc.). In a volatile memory device, the stored data is lost when the memory device is powered off. On the other hand, in a non-volatile memory device, the stored data is maintained even when the memory device is powered off.

Flash memory devices are widely used as high-capacity storage media in computing devices. Recently, various technologies have been developed to support high-speed operation of flash memory devices. For example, Universal Flash Storage (UFS) (e.g., defined by the Joint Electron Device Engineering Council (JEDEC) standard) has higher operating speeds than those of storage devices based on traditional flash memories.

### SUMMARY

According to one aspect of the present disclosure, a computer-executed method is provided. The method may include receiving a first request sent from a first virtual machine. The first virtual machine may be configured to emulate a host. The method may include establishing communication between the first virtual machine and a second virtual machine in response to the first request. The second virtual machine may be configured to emulate a memory system.

In some implementations, the first request may include first address information of the first virtual machine. In some implementations, the establishing communication between the first virtual machine and a second virtual machine in response to the first request may include sending the first request to the second virtual machine. In some implementations, the establishing communication between the first virtual machine and a second virtual machine in response to the first request may include receiving second address information sent from the second virtual machine. In some implementations, the second address information may be determined based on the first request. In some implementations, the establishing communication between the first virtual machine and a second virtual machine in response to the first request may include establishing a link between the first virtual machine and the second virtual machine based on the first address information and the second address information.

In some implementations, the establishing communication between the first virtual machine and a second virtual machine in response to the first request may further include establishing a mapping relationship between the first virtual machine and the second virtual machine based on the first address information and the second address information.

In some implementations, the first request may further include an operation command. In some implementations, the establishing communication between the first virtual machine and a second virtual machine in response to the first request may further include sending data information sent from the first virtual machine to the second virtual machine in response to the operation command. In some implementations, the establishing communication between the first virtual machine and a second virtual machine in response to the first request may further include sending the data information sent from the second virtual machine to the first virtual machine in response to the operation command.

In some implementations, the method may further include buffering the data information.

In some implementations, the method may further include receiving a second request sent from at least one of the first virtual machine or the second virtual machine. In some implementations, the method may further include disconnecting the communication between the first virtual machine and the second virtual machine in response to the second request. In some implementations, the second request may be different from the first request.

In some implementations, the disconnecting the communication between the first virtual machine and a second virtual machine in response to the second request may include clearing the mapping relationship between the first virtual machine and the second virtual machine in response to the second request.

In some implementations, the second request may include a disconnect request or a timeout request.

In some implementations, the first virtual machine and the second virtual machine may be generated by a same computer device. In some implementations, a manner for the communication between the first virtual machine and the second virtual machine includes inter-process communication.

In some implementations, the first virtual machine and the second virtual machine may be generated by different computer devices. In some implementations, a manner for the communication between the first virtual machine and the second virtual machine includes network communication.

In some implementations, the memory system may include Universal Flash Storage.

According to another aspect of the present disclosure, a system is provided. The system may include a processor. The system may include a buffer storing instructions. The buffer storing instructions, which when executed by the processor, may cause the processor to receive a first request sent from a first virtual machine. The first virtual machine may be configured to emulate a host. The buffer storing instructions, which when executed by the processor, may cause the processor to establish communication between the first virtual machine and a second virtual machine in response to the first request, the second virtual machine being configured to emulate a memory system.

In some implementations, the first request may include first address information of the first virtual machine. In some implementations, the buffer storing instructions, which when executed by the processor, may further cause the processor to send the first request to the second virtual machine. In some implementations, the buffer storing instructions, which when executed by the processor, may further cause the processor to receive second address information sent from the second virtual machine, the second address information being determined based on the first request. In some implementations, the buffer storing instructions, which when executed by the processor, may further cause the processor to establish a link between the first virtual machine and the second virtual machine based on the first address information and the second address information.

In some implementations, the buffer storing instructions, which when executed by the processor, may further cause the processor to receive a second request sent from at least one of the first virtual machine or the second virtual machine. In some implementations, the buffer storing instructions, which when executed by the processor, may further cause the processor to disconnect the communication between the first virtual machine and the second virtual machine in response to the second request, the second request being different from the first request.

In some implementations, the processor may include a first processor and a second processor from different computing devices in the system. In some implementations, the buffer storing instructions, which when executed by the first processor, may cause the first processor to run a first development platform, and to generate the first virtual machine through the first development platform. In some implementations, the buffer storing instructions, which when executed by the second processor, may cause the second processor to run the first development platform, and to generate the second virtual machine through the first development platform.

In some implementations, the buffer storing instructions, which when executed by the first processor or the second processor, may cause the first processor or the second processor to run a second development platform. In some implementations, the buffer storing instructions, which when executed by the first processor or the second processor, may cause the first processor or the second processor to generate a communication management module. In some implementations, the buffer storing instructions, which when executed by the first processor or the second processor, may cause the first processor or the second processor to buffer instructions corresponding to the communication management module into the buffer, the second development platform being different from the first development platform.

In some implementations, the processor may include a processor of a same computing device in the system. In some implementations, the buffer storing instructions, which when executed by the processor, may cause the processor to run a first development platform. In some implementations, the buffer storing instructions, which when executed by the processor, may cause the processor to generate the first virtual machine and the second virtual machine through the first development platform.

In some implementations, the buffer storing instructions, which when executed by the processor, may cause the processor to run a second development platform. In some implementations, the buffer storing instructions, which when executed by the processor, may cause the processor to generate a communication management module. In some implementations, the buffer storing instructions, which when executed by the processor, may cause the processor to buffer instructions corresponding to the communication management module into the buffer, the second development platform being different from the first development platform.

In some implementations, the first development platform may include a virtual operating system emulator. In some implementations, the second development platform may include a C-language development platform.

According to a further aspect of the present disclosure, a non-transitory computer-readable storage medium is provided. The non-transitory computer-readable store medium may have instructions stored thereon. The instructions, which when executed by a processor may cause the processor to receive a first request sent from a first virtual machine. The first virtual machine may be configured to emulate a host. The instructions, which when executed by a processor may cause the processor to establish communication between the first virtual machine and a second virtual machine in response to the first request. The second virtual machine may be configured to emulate a memory system.

### BRIEF DESCRIPTION OF THE DRAWINGS

FIG. 1 is a schematic diagram of the communication process between the host and the UFS device in an illustrated example.

FIG. 2 is a schematic diagram of the host and the UFS device in an illustrated example.

FIG. 3 is a first schematic flowchart of a computer-executed method in an example of the present disclosure.

FIG. 4 is a schematic diagram of the first virtual machine and the second virtual machine being located on a same computer device in an example of the present disclosure.

FIG. 5 is a schematic diagram of the first virtual machine and the second virtual machine being located on different computer devices in an example of the present disclosure.

FIG. 6 is a second schematic flowchart of a computer-executed method in an example of the present disclosure.

FIG. 7 is a schematic diagram of the communication process of establishing a link between the first virtual machine and the second virtual machine in an example of the present disclosure.

FIG. 8 is a third schematic flowchart of a computer-executed method in an example of the present disclosure.

FIG. 9 is a fourth schematic flowchart of a computer-executed method in an example of the present disclosure.

FIG. 10 is a schematic diagram of the communication process between the first virtual machine and the second virtual machine in an example of the present disclosure.

FIG. 11 is a schematic diagram of the communication process of buffered data between the first virtual machine and the second virtual machine in an example of the present disclosure.

FIG. 12 is a fifth schematic flowchart of a computer-executed method in an example of the present disclosure.

FIG. 13 is a sixth schematic flowchart of a computer-executed method in an example of the present disclosure.

FIG. 14 is a first schematic diagram 1 of disconnecting the link between the first virtual machine and the second virtual machine in an example of the present disclosure.

FIG. 15 is a second schematic diagram of disconnecting the link between the first virtual machine and the second virtual machine in an example of the present disclosure.

FIG. 16 is a third schematic diagram of disconnecting the link between the first virtual machine and the second virtual machine in an example of the present disclosure.

FIG. 17 is a fourth schematic diagram of disconnecting the link between the first virtual machine and the second virtual machine in an example of the present disclosure.

FIG. 18 is a schematic diagram of a system provided by an example of the present disclosure.

### DETAILED DESCRIPTION

In order to facilitate understanding of the present application, the present application will be described more comprehensively below with reference to the related accompanying drawings. Some examples of the present application are shown in the accompanying drawings. However, the present application may be implemented in many different forms and is not limited to the examples described herein. Rather, these examples are provided to make this disclosure thorough and comprehensive.

Unless otherwise defined, all technical and scientific terms used herein have the same meaning as commonly understood by those skilled in the art to which this application belongs. The terminology used herein in the description of the application is only for the purpose of describing some examples and is not intended to limit the application. As used herein, the term “and/or” includes any and all combinations of one or more of the associated listed items.

The system described herein may include, e.g., one or more computer devices. A computer device as described herein may include, e.g., a host and a memory system. A computer device as described herein may include, e.g., desktop computer, laptop, tablet, vehicle computer, server, mobile phone, etc. A host may include, e.g., a processor of an electronic device (e.g., a Central Processing Unit (CPU)) or a System on Chip (SoC) (e.g., an Application Processor (AP)).

The host may be configured to send data to or receive data from the memory system.

Here, the memory system may include a memory controller and one or more memories. A memory may include, but is not limited to, a Not-And (NAND) Flash Memory, Vertical NAND Flash Memory, NOR Flash Memory, Dynamic Random Access Memory (DRAM), Ferroelectric Random Access Memory (FRAM), Magnetoresistive Random Access Memory (MRAM), Phase Change Random Access Memory (PCRAM), Resistive Random Access Memory (RRAM) and Nano Random Access Memory (NRAM), etc.

In an example of the present disclosure, a memory controller may be coupled to the memory and the host, and used to control the memory. In one example, the memory controller may be designed to operate in low duty cycle environments, e.g., Secure Digital (SD) card, Compact Flash (CF) card, Universal Serial Bus (USB) flash drive, or other media for use in electronic devices such as personal computer, digital camera, mobile phone, etc. In some examples, the memory controller may also be designed to operate in high duty cycle environments, e.g., such as Solid State Drive (SSD) or embedded Multi-Media Card (eMMC), and SSDs or eMMCs may be used as data storage for mobile devices such as smartphone, tablet computer, laptop computer, and enterprise storage array.

Further, the memory controller may manage data in the memory and communicate with the host. The memory controller may be configured to control operations such as read, erase, and write of a memory. The memory controller may be configured to manage various functions related to data stored or to be stored in a memory. These functions may include, but are not limited to, e.g., bad block management, garbage collection, logical-to-physical address translation, wear leveling, etc., The memory controller may be configured to process Error Checking and Correction (ECC) on data read from or written to the memory. In addition, the memory controller may also perform any other suitable functions, e.g., formatting the memory, or communicating with external devices (e.g., a host) according to a communication protocol.

The memory controller may also communicate with the host through at least one of various interface protocols, such as Universal Serial Bus (USB) protocol, Multi-Media Card (MMC) protocol, Peripheral Component Interconnect (PCI) protocol, Peripheral Component Interconnect Express (PCI-E) protocol, Advanced Technology Attachment (ATA) protocol, Serial ATA protocol, Parallel ATA protocol, Small Computer System Interface (SCSI) protocol, Enhanced Small Disk Interface (ESDI) protocol, Integrated Drive Electronics (IDE) protocol, Fire wire protocol, etc.

In an example of the present disclosure, a memory controller and one or more memory may be integrated into various types of storage devices, e.g., included in a same package (e.g., UFS package or eMMC package). That is, a memory system may be implemented and packaged into different types of end electronic products. For example, a memory controller and a single memory may be integrated together to form a memory card. A memory card may include a PC card (e.g., Personal Computer Memory Card International Association), a CF card, a Smart Media (SM) card, a memory stick, a Multi-Media card (MMC), Reduced-Size MMC (RS-MMC), MMCmicro, an Secure Digital (SD) card (e.g., miniSD, microSD, Secure Digital High Capacity (SDHC)), Universal Flash Storage (UFS), etc. A memory card may further include a memory card connector coupling the memory card with a host (e.g., host). In an example, a memory controller and multiple memories may be integrated together to form an SSD. The SSD may also include an SSD connector coupling the SSD to the host. In some examples, at least one of the storage capacity or operating speed of SSD is greater than at least one of the storage capacity or operating speed of memory card. The high-speed operation between the host and the memory system will directly affect the performance of the computer device.

The following description will be made by taking the memory system as a Universal Flash Storage (e.g., UFS device) as a non-limiting example.

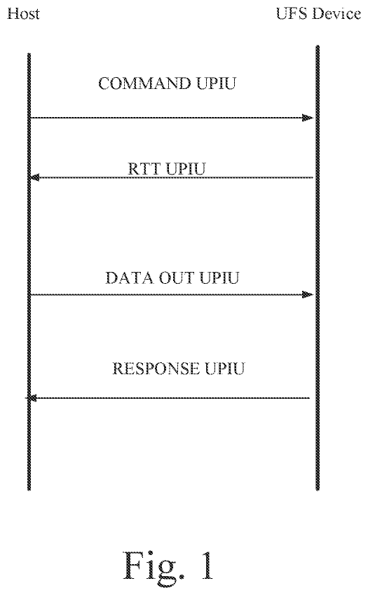

FIG. 1 describes the process of a host writing data to a UFS device. To begin, the host may send a COMMAND UFS Protocol Information Unit (UPIU). The COMMAND UPIU may include the basic UPIU header (Header) and additional information required for the specified command. The COMMAND UPIU informs the UFS device of the data information that is to be written. The host receives the Ready To Transfer (RTT) UPIU sent by the UFS device. The RTT UPIU indicates that the UFS device may accept the data transmission from the host. The host performs data transmission through the DATA OUT UPIU. Finally, the host receives a RESPONSE UPIU, which indicates the end of the current write command. The execution process of other commands is similar. Here, the host may send data to the UFS device through one or more DATA OUT UPIU commands.

UPIU is a data packet that carries a command, data, and/or status information. A UPIU data packet has a fixed format. For instance, each UPIU has a 12-byte Header, plus fields related to each UPIU. A UPIU (including Header) has a minimum size of 32 bytes and a maximum size of 65600 bytes. The Header includes information associated with the Transaction Type, which is used to describe the UPIU type (e.g., command, data, and/or status information).

COMMAND UPIU indicates the command sent by the host to the UFS device, including operation command, e.g., such as read, write, erase, etc. COMMAND UPIU contains information such as the type, length, and parameters of the command, and the UFS device may perform corresponding operations according to this information.

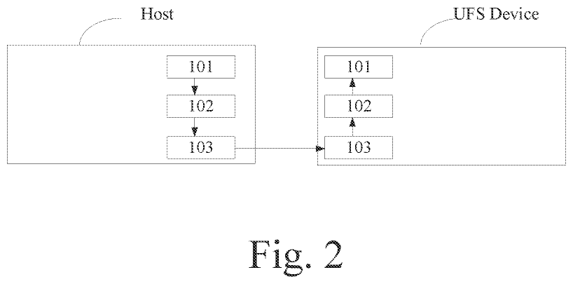

The communication between the host and the UFS device is based on the hierarchical communication architecture of the SCSI model. As shown in FIG. 2, from bottom to top, there is an interconnect layer 101 (UFS InterConnect Layer, UIC), a transport layer 102 (UFS Transport Layer, UTP), and an application layer 103 (e.g., UFS Application Layer (UAP)) in sequence.

For example, the process of the host sending a COMMAND UPIU to a UFS device may include, e.g., 1) issuing a SCSI command by the application layer 101 of the host, 2) receiving the SCSI command and packaging it into a UPIU that the UFS device may identify (e.g., command UPIU) by the transport layer 102 of the host, 3) sending the UPIU command to the interconnect layer 103 of the UFS device through an electrical signal (e.g., the interconnect layer 103 is used to implement the link between the host and the UFS device) by the interconnect layer 103 of the host. The interconnect layer 103 of the UFS device receives the electrical signal, and repackages the electrical signal into a COMMAND UPIU format through the transport layer 102 of the UFS device, and the application layer 101 of the UFS device receives the COMMAND UPIU and responds to the COMMAND UPIU.

The communication process between the host and the UFS device may be executed through the application layer 101, the transport layer 102, and the interconnect layer 103 between the host and the UFS device. This makes the communication process extremely cumbersome and increases the communication time, which reduces the speed and increases the complexity of operations speed between the host and the UFS device. Thus, there is an unmet need for a simplification of communication process between the host and the UFS device.

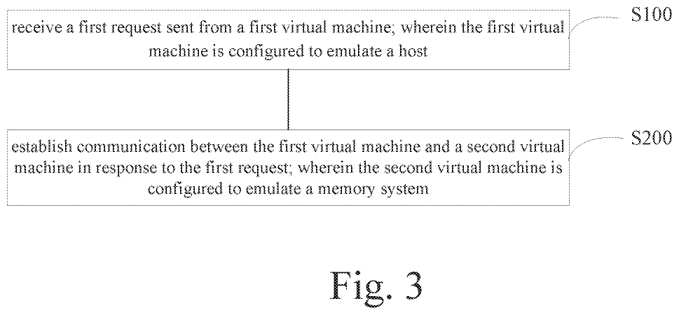

To overcome these and other challenges, an example of the present disclosure provides a computer-executed method, as shown in FIG. 3. The method of FIG. 3 may include operations S100 and S200.

Referring to FIG. 3, at operation S100, the method may include receiving a first request sent from a first virtual machine. The first virtual machine may be configured to emulate a host.

At operation S200, the method may include establishing communication between the first virtual machine and a second virtual machine in response to the first request. The second virtual machine may be configured to emulate a memory system.

In some examples, the method described above is applied to a communication management module in a computer device.

For instance, at operation S100, the communication management module may receive a first request sent by the first virtual machine.

At operation S200, the communication management module may parse the first request and send the parsed result to the second virtual machine. The second virtual machine responds according to the received parsed result, and returns the response result to the communication management module. Thus, the communication management module may establish communication between the first virtual machine and the second virtual machine.

It is understood that the communication management module is configured to implement communication between the first virtual machine and the second virtual machine, and the communication management module may be stored in the buffer as software program code and configured to implement the methods of examples of the present disclosure when executed by the processor. The communication management module may be a program generated based on a computer language and a development platform (e.g., a second development platform). The development platform may include a software program code compiled and generated with C language. In other non-limiting examples, the communication management module may also be compiled and generated with other computer languages.

In the example of the present disclosure, the first virtual machine emulates the host to implement the functions of the host; and the second virtual machine emulates the memory system to implement the functions of the memory system. For example, the host may send data to or receive data from the memory system. Accordingly, the first virtual machine may send data to or receive data from the second virtual machine. Here, the host emulated by the first virtual machine and the memory system emulated by the second virtual machine may be from a same computer device or may be from different computer devices, without limitation.

In an example of the present disclosure, the communication management module may receive a first request sent from the first virtual machine, and in response to the first request, establish communication between the first virtual machine and the second virtual machine. Since the first virtual machine and the second virtual machine emulate the host and the storage system respectively, the complex communication requirements between the host and the storage system may be implemented through the communication management module, the first virtual machine, and the second virtual machine. In this way, the communication process between the host and the memory system may be implemented without the interconnect layer, transport layer, and application layer. This simplifies the communication process between the host and the memory system, shortens the communication time, and increases the communication speed within the same computer device or between different computer devices.

In some examples, the first virtual machine and the second virtual machine are generated by a same computer device. The communication manner between the first virtual machine and the second virtual machine includes inter-process communication.

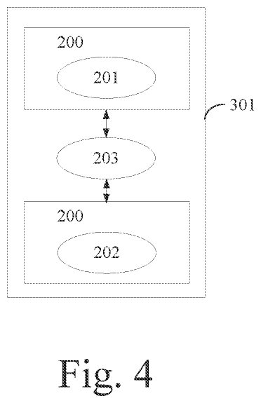

As shown in FIG. 4, a virtual environment is created through running the first development platform 200 on the first computer device 301, and multiple virtual machines are generated in the virtual environment. The multiple virtual machines may include a first virtual machine 201 and a second virtual machine 202. The first virtual machine 201 may be configured to emulate a host to implement the functions of the host; and the second virtual machine 202 may be configured to emulate a memory system to implement the functions of the memory system. For example, the host may be configured to send data to or receive data from the memory system. Accordingly, the first virtual machine 201 may be configured to send data to or receive data from the second virtual machine 202. Here, the first computer device 301 is a host machine for multiple virtual machines.

In some implementations, the first computer device 301 may be different from the computer device associated with the host emulated by the first virtual machine 201 and the memory system emulated by the second virtual machine 202. The first virtual machine 201 and the second virtual machine 202 generated on the first computer device 301 may emulate a host and a memory system associated with other computer devices.

It should be noted that emulation of different objects may be implemented through writing different parameter codes in the first development platform 200. For example, the parameter code corresponding to the host may be written in the first development platform 200 to generate the first virtual machine 201 to emulate the host, and the parameter code corresponding to the UFS device may be written in the first development platform 200 to generate the second virtual machine 202 to emulate the UFS device.

The first development platform 200 may include an emulator that may implement hardware virtualization, e.g., a virtual operating system emulator (Quick Emulator (QEMU)), VirtualBOX (Oracle VM VirtualBox), Vmware, and KVM (Kernel-based Virtual Machine), etc. In the description set forth herein, the present disclosure takes the first development platform 200 being QEMU as a non-limiting example.

In some examples, the first development platform 200 may emulate the entire host, including the central processor and other peripheral devices (e.g., a memory device). The first development platform 200 makes it easy to test and debug programs written across platforms.

The communication between the first virtual machine 201 and the second virtual machine 202 may include, e.g., establishing a link, disconnecting a link, data transmission, etc. The communication between the first virtual machine 201 and the second virtual machine 202 will be described in detail in the following examples, and will not be repeated here.

It is understood that in an example of the present disclosure, since the first virtual machine 201 and the second virtual machine 202 run on the same computer device, the communication between the first virtual machine 201 and the second virtual machine 202 may be implemented through Inter-Process Communication (IPC). The inter-process communication may include, but is not limited to, pipeline communication, shared memory communication, Socket communication, message queue communication, etc.

In some examples, the first virtual machine and the second virtual machine are generated by different computer devices. The communication between the first virtual machine and the second virtual machine may be implemented using network communications.

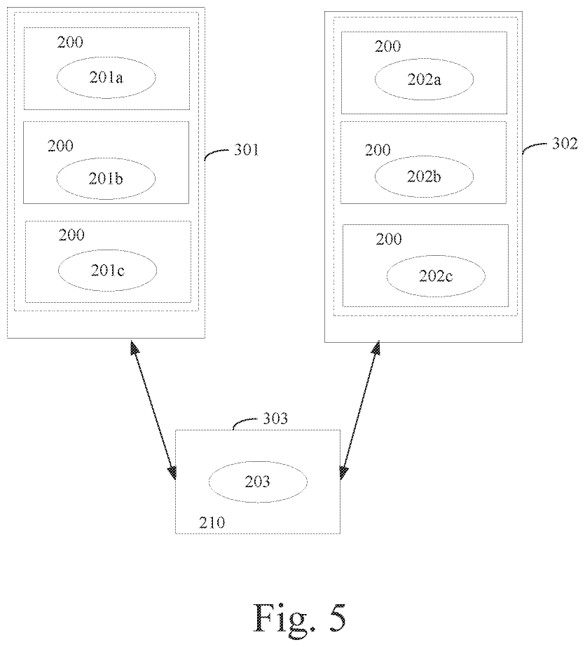

As shown in FIG. 5, through running the second development platform 210 on the third computer device 303, the communication management module 203 may be compiled and generated with C language. A virtual environment is created through running the first development platform 200 on the first computer device 301, and at least one first virtual machine 201 (e.g., a first first virtual machine 201a, a second first virtual machine 201b, and a third first virtual machine 201c) is generated in the virtual environment. A virtual environment is created on the second computer device 302 through running the first development platform 200, and at least one second virtual machine 202 (e.g., a first second virtual machine 202a, a second second virtual machine 202b, and a third second virtual machine 202c) is generated in the virtual environment. The first virtual machine 201 is configured to emulate a host to implement the functions of the host. The second virtual machine 202 is configured to emulate a memory system to implement the functions of the memory system. Here, the first computer device 301 is the host machine of the first virtual machine 201, and the second computer device 302 is the host machine of the second virtual machine 202. It should be noted that the first computer device 301 and the second computer device 302 may be different from the computer device in which the host emulated by the first virtual machine 201 and the memory system emulated by the second virtual machine 202 are comprised. In other words, the first virtual machine 201 generated on the first computer device 301 and the second virtual machine 202 generated on the second computer device 302 may emulate hosts and memory systems comprised in other computer devices.

It may be understood that in an example of the present disclosure, since the first virtual machine 201 and the second virtual machine 202 run on different computer devices, the communication between the first virtual machine 201 and the second virtual machine 202 may be implemented through the way of network communication, and the way of network communication includes but is not limited to TCP/IP (Transmission Control Protocol/Internet Protocol) communication and WebSocket communication.

In some examples, the second development platform 210 may also run on the first computer device 301, and the communication management module 203 may be complied and generated with C language. It may be understood that in this example, the first virtual machine 201 and the communication management module 203 may be in a same computer device (e.g., the first computer device 301), and the second virtual machine may be in another computer device (e.g., the second computer device 302).

In some examples, when the first virtual machine 201 and the communication management module 203 are in the first computer device 301. The second virtual machine 202 is in the second computer device 302. The communication between the first virtual machine 201 and the communication management module 203 may be implemented through inter-process communication. The communication between the second virtual machine 202 and the communication management module 203 may be implemented through network communication.

In some examples, the second development platform 210 may also run on the second computer device 302, and the communication management module 203 may be complied and generated with C language. It may be understood that in this example, the second virtual machine 202 and the communication management module 203 may be in a same computer device (e.g., the second computer device 302), and the first virtual machine 201 may be in another computer device (e.g., the first computer device 301).

In some examples, when the second virtual machine 202 and the communication management module 203 are in the second computer device 302, and the first virtual machine 201 is in the first computer device 301. The communication between the second virtual machine 202 and the communication management module 203 may be complemented by inter-process communication. The communication between the first virtual machine 201 and the communication management module 203 may be complemented by network communication.

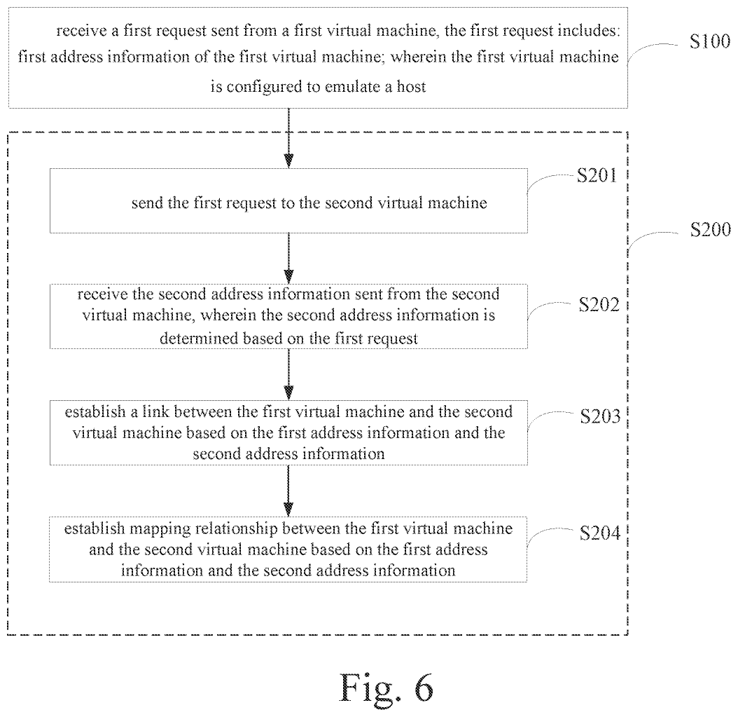

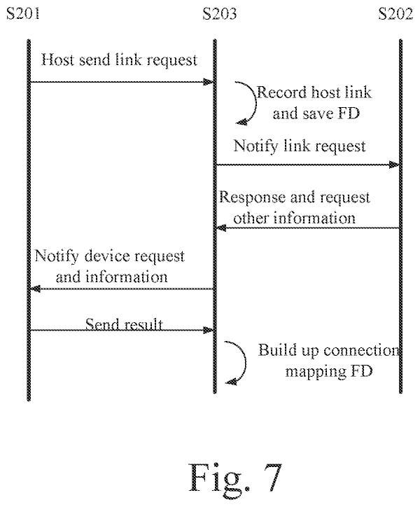

FIG. 6 is a schematic flowchart of a computer-executed method in an example of the present disclosure. FIG. 7 is a schematic diagram of the communication process of establishing a link between the first virtual machine 201 and the second virtual machine 202 in an example of the present disclosure. The communication process of establishing a link between the first virtual machine 201 and the second virtual machine 202 will be further described below with reference to FIGS. 6 and 7.

In some examples, the first request may include first address information of the first virtual machine. As shown in FIG. 6, operation S200 described above may include operations S201, S202, and S203.

At operation S201, the method may include sending the first request to the second virtual machine.

At operation S202, the method may include receiving second address information sent from the second virtual machine. The second address information may be determined based on the first request.

At operation S203, the method may include establishing a link between the first virtual machine and the second virtual machine based on the first address information and the second address information.

At operation S201, the communication management module sends the received first request to the second virtual machine.

At operation S202, the response result of the second virtual machine is second address information, and the communication management module receives the second address information sent from the second virtual machine.

At operation S203, the communication management module establishes a link between the first virtual machine and the second virtual machine based on the first address information and the second address information.

As shown in FIG. 7, at operation S201, in one example, the sending the first request to the second virtual machine may include, e.g., the first virtual machine 201 sending the first request (e.g., Host send link request) to the communication management module 203. The communication management module 203 may receive the first request and send the first request to the second virtual machine 202 (e.g., Notify link request). The first request may be a link request, and the link request includes a File Descriptor (FD). The file descriptor may include first address information.

In an example, the communication between the first virtual machine 201 and the second virtual machine 202 may include inter-process communication, and the first address information may include the process ID of the first virtual machine 201. For example, the first virtual machine 201 may establish a link with the second virtual machine 202. Here, the process ID of the first virtual machine 201 is sent to the second virtual machine 202 through the file descriptor. Then, the second virtual machine 202 responds, and the communication management module 203 records the process ID of the second virtual machine 202 and saves the new file descriptor, thereby the first virtual machine 201 and the second virtual machine 202 are successfully paired (e.g., a link is established).

In another example, if the communication between the first virtual machine 201 and the second virtual machine 202 includes network communication, the file descriptor includes first address information. The first address information may include a sending IP and a sending port. After the link is established successfully, the communication management module 203 records the linking request and saves the new file descriptor. The file descriptor includes information of both sides of the link, e.g., sending IP, receiving IP, sending port, receiving port, and link relationship, etc.

Here, the communication management module 203 may function the recording. For example, recording the link situation between the first first virtual machine 201a and the second second virtual machine 202b in FIG. 5.

As shown in FIG. 7, at operation S202, second address information sent from the second virtual machine is received. The second address information is determined based on the first request.

The first address information may include a logical address sent by the first virtual machine, and the second address information may include a physical address determined based on the logical address.

In one example, the computer device includes a second virtual machine 202, and the second address information may include the physical address of at least part of the virtual storage space in the second virtual machine. In another example, the computer device includes multiple second virtual machines 202, and the second address information may include a physical address of a target second virtual machine in the multiple second virtual machines 202 and the physical address of at least part of the virtual storage space within the target second virtual machine. Here, the target second virtual machine is a second virtual machine communicating with the first virtual machine 201.

In some examples, referring to FIG. 5, multiple first virtual machines are created on the first computer device 301 through running the first development platform 200, e.g., a first first virtual machine 201a, a second first virtual machine 201b and a third first virtual machine 201c. Multiple second virtual machines are created on the second computer device 302 through running the first development platform 200, e.g., a first second virtual machine 202a, a second second virtual machine 202b and a third second virtual machine 202c. Here, at least one of the following cases occurs: 1) each first virtual machine may communicate with at least one of multiple second virtual machines, or 2) each second virtual machine may communicate with at least one of multiple first virtual machines.

In some examples, the first request is to indicate that communication is made with the target second virtual machine. Taking the communication between the first first virtual machine 201a and the first second virtual machine 202a as an example, the first first virtual machine 201a sends a first request to the communication management module 203, and the first request includes the logical address corresponding to the first second virtual machine 202a. The communication management module 203 may determine the physical address of the first second virtual machine 202a and the status of the first second virtual machine 202a (e.g., busy or idle) based on the logical address, when the first second virtual machine 202a is idle, the first second virtual machine 202a reports IDLE to the communication management module 203, and data may be directly written into the first second virtual machine 202a. When the first second virtual machine 202a is busy, the first second virtual machine 202a reports BUSY to the communication management module 203, and may wait in queue until the first second virtual machine 202a is idle. It may be understood that in this example, the first second virtual machine 202a is the target virtual machine, and the first request indicates communication may be made with the assigned second virtual machine.

In some examples, the first request is to indicate that communication may be made with the second virtual machine, and the communication management module 203 may determine the status (busy or idle) of the multiple second virtual machines based on the first request, and determine the target second virtual machine according to the status of the multiple second virtual machines. For example, taking the first second virtual machine 202a and the third second virtual machine 202c being busy and the second second virtual machine 202b being idle as an example, the first second virtual machine 202a and the third second virtual machine 202c report busy to the communication management module 203, and the second second virtual machine 202b reports idle to the communication management module 203. The first virtual machine sends the logical address of the data to be written to the communication management module 203. The communication management module 203 determines the physical address of at least part of the virtual storage space in the second second virtual machine 202b based on the logical address, and writes the data into the second second virtual machine 202b. It may be understood that in this example, the second second virtual machine 202b is a target virtual machine, and the first request indicates communication may be made with the second virtual machine, and the target second virtual machine is determined according to the status of the multiple second virtual machines.

In some examples, if the writing succeeds, the second address information of the second virtual machine and the information of a successful writing may be returned to the communication management module 203. In other examples, if the writing fails, e.g., the remaining virtual storage space in the second virtual machine is insufficient, the second address information of the second virtual machine and the information of a failed writing may be returned to the communication management module 203.

After responding, the second virtual machine may send the second address information (e.g., process ID, receiving IP) of the second virtual machine to the communication management module 203.

At operation S202, the communication management module 203 receives a response from the second virtual machine 202 and a request for other information sent by the second virtual machine 202 (e.g., Response and request other information). Other information may include content contained in the UFS protocol. The communication management module 203 notifies the host of the request for other information sent by the second virtual machine 202 (e.g., Notify device request and information). The first virtual machine 201 sends the result of whether the establishment is successful (e.g., Send result) to the communication management module 203.

In the example of the present disclosure, before the first virtual machine and the second virtual machine communicate, a link between the first virtual machine and the second virtual machine may be established with the communication management module 203.

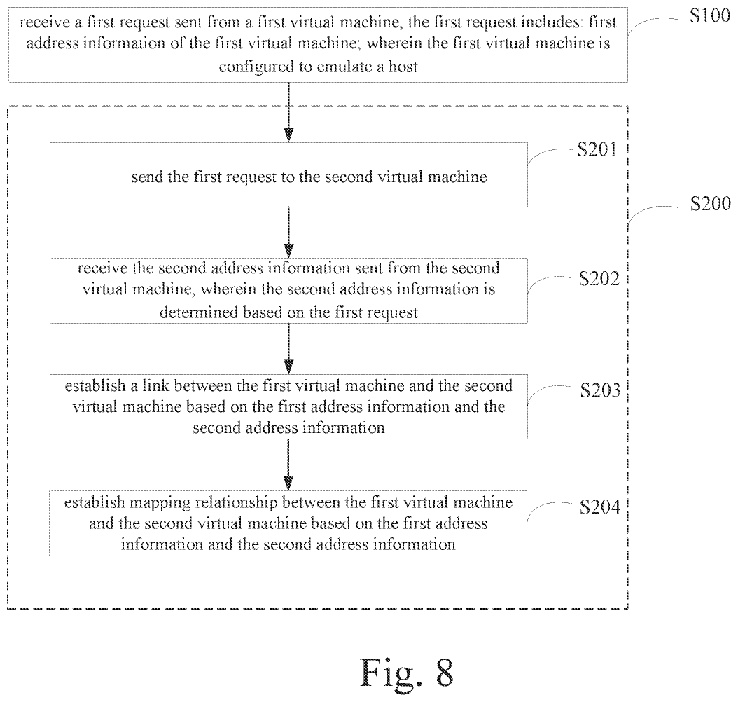

In some examples, as shown in FIG. 8, the operation S200 described above further includes operation S204.

For example, referring to FIG. 8, at operation S204, the method may include establishing mapping relationship between the first virtual machine and the second virtual machine based on the first address information and the second address information.

At operation S204, based on the first address information and the second address information, the communication management module, after successfully establishes the link, may also establish mapping relationship between the first virtual machine and the second virtual machine, and save the mapping relationship in the communication management module by the manner of a file descriptor to facilitate subsequent management by the communication management module.

In some examples, as shown in FIG. 7, if the first virtual machine 201 sends a result of a successful establishment (e.g., Send result=success) to the communication management module 203, the communication management module 203 may establish a mapping relationship between the first virtual machine and the second virtual machine (e.g., Build up connection mapping FD).

When establishing a link, the communication management module 203 creates a new FD and links the new FD with the corresponding network relationship. This network relationship may be stored in a data structure, e.g., a hash table or an array. This data structure may be used to search for the network link corresponding to the specified FD, or the FD corresponding to the specified network link.

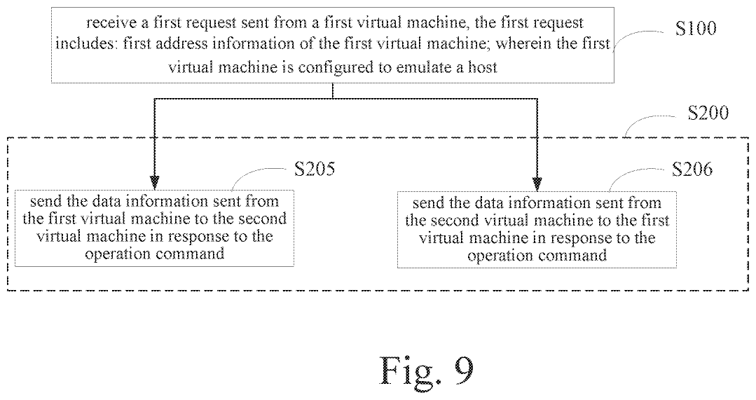

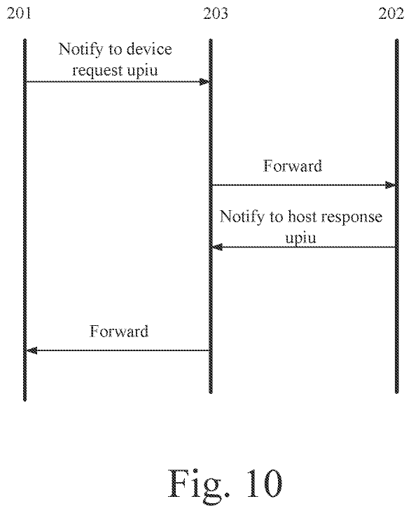

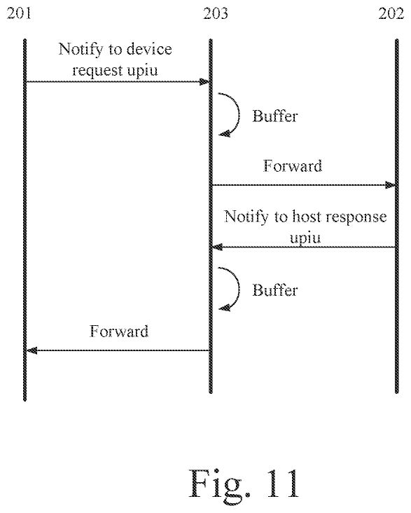

FIG. 9 is a schematic flowchart of a computer-executed method in an example of the present disclosure. FIGS. 10 to 11 are schematic diagrams of the communication process of performing data transmission between the first virtual machine 201 and the second virtual machine 202 in an example of the present disclosure. The communication process of performing data transmission between the first virtual machine 201 and the second virtual machine 202 will be further described below with reference to FIGS. 9, 10 and 11.

In some examples, as shown in FIG. 9, the first request further includes an operation command. As shown in FIG. 9, operation S200 may further include operation S205 or operation S206.

Referring to FIG. 9, at operation S205, the method may include sending the data information sent from the first virtual machine to the second virtual machine in response to the operation command.

Also referring to FIG. 9, at operation S206, the method may include sending the data information sent from the second virtual machine to the first virtual machine in response to the operation command.

In some examples, the content of the UFS protocol may be emulated for communication between the paired virtual machines.

The first request further includes: an operation command. The operation command may include a command or request UPIU, a data transmission related UPIU, and a reply UPIU.

At operation S205, the communication management module 203, after establishing the link between the first virtual machine and the second virtual machine, receives the data information sent from the first virtual machine, and continues to send the data information to the second virtual machine.

At operation S206, the communication management module 203, after establishing the link between the first virtual machine and the second virtual machine, receives the data information sent from the second virtual machine, and continues to send the data information to the first virtual machine.

In some examples, as shown in FIG. 10, the first virtual machine 201 may send a request UPIU (e.g., Notify to device request UPIU) to the second virtual machine 202, and the communication management module 203 firstly receives the request UPIU, and then continues to transmit the request UPIU to the second virtual machine 202 (e.g., Forward).

A request UPIU may include various types of requests, e.g., a read request (a request to read data from the memory system), a write request (a request to write data to the memory system), a configuration request (a request to configure or manage operations on a device), etc.

The request UPIU includes information such as address and length of the requested data, and the second virtual machine 202 may return corresponding data according to the information.

The second virtual machine 202 sends a reply UPIU (e.g., Notify to host request UPIU) to the first virtual machine 201, and the communication management module 203 receives the reply UPIU, and then continues to transmit the reply UPIU to the first virtual machine 201 (e.g., Forward).

The reply UPIU returns the operation result to the first virtual machine 201, and may include content such as, e.g., status content indicating whether the second virtual machine 202 completes the requested operation, and/or Data content containing the data or result of the requested operation. For example, if it is a read request, the reply UPIU will contain the data to be read into the first virtual machine 201.

In some examples, as shown in FIG. 11, the method described above may further include buffering data information (e.g., Buffer).

In the debugging mode, the communication management module 203 may buffer the UPIU sent by the host or the UPIU sent by the device for subsequent viewing. The communication management module 203 also includes a virtual storage region for buffering commands, data information, etc.

As shown in FIG. 11, the first virtual machine 201 sends a request UPIU to the second virtual machine 202, and the communication management module 203 receives the request UPIU, buffers the request UPIU, and then transmits the request UPIU to the second virtual machine 202.

The second virtual machine 202 sends a reply UPIU to the host, and the communication management module 203 firstly receives the reply UPIU, buffers the reply UPIU, and then continues to transmit the reply UPIU to the first virtual machine 201. In some examples, the reply UPIU responds according to the header of the request UPIU and additional information, which may be associated with the assigned command. The header of the reply UPIU may include Command Tag ID and Status. Command Tag ID is to indicate which request the UPIU responds to. For example, when the Command Tag ID of the request UPIU corresponds to the Command Tag ID of the reply UPIU, the reply UPIU corresponds to the request UPIU.

The status indicates whether the request UPIU was processed successfully or unsuccessfully. By way of example and not limitation, binary data “0” may be to indicate a success, and binary data “1” may be to indicate a failure. In some examples, if the request UPIU further requests additional information (e.g., a file descriptor), the reply UPIU may also include a string of data information.

In some examples, the data buffered in the virtual storage region of the communication management module 203 may be automatically deleted when the debugging mode is exited or other modes are switched thereto. This optimizes the space of the communication management module, and improves the communication speed of the computer device.

In some examples, the data buffered in the virtual storage region of the communication management module 203 may also be manually deleted.

In an example of the present disclosure, the communication management module 203 may also monitor the communication content between the first virtual machine 201 and the second virtual machine 202 to implement the function of a protocol analyzer. The protocol analyzer is a special testing tool that monitors the data flow in the data communication system and checks whether the data exchange is carried out correctly in accordance with the provisions of the protocol.

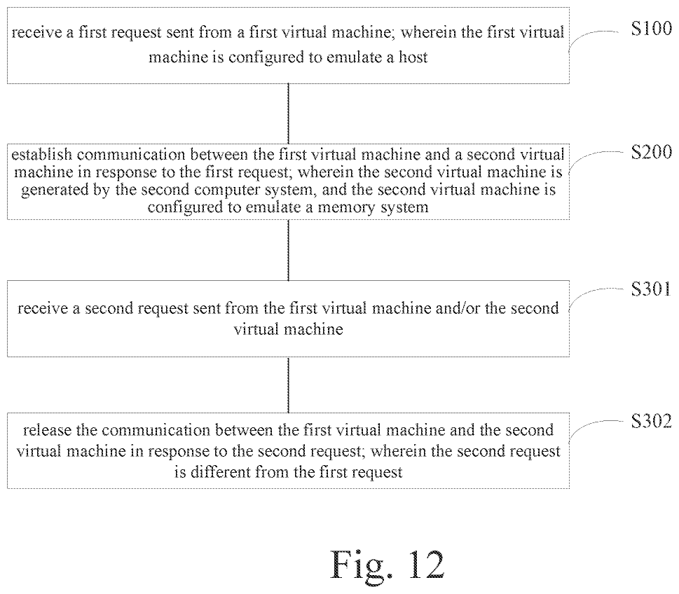

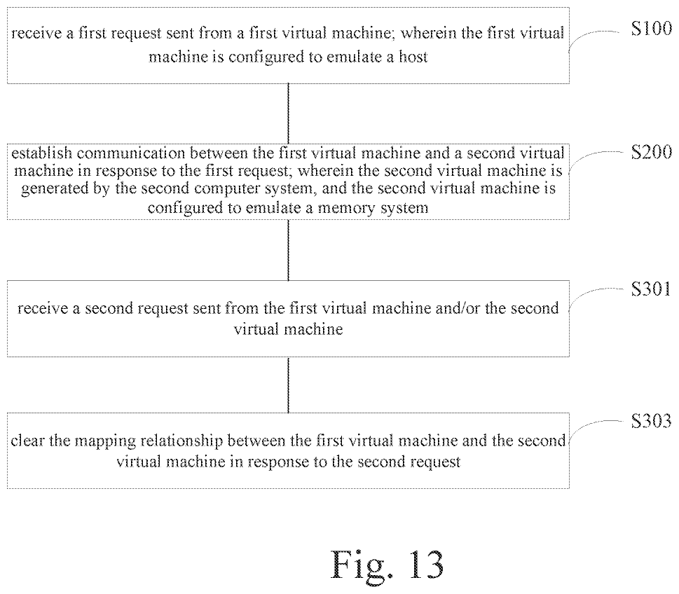

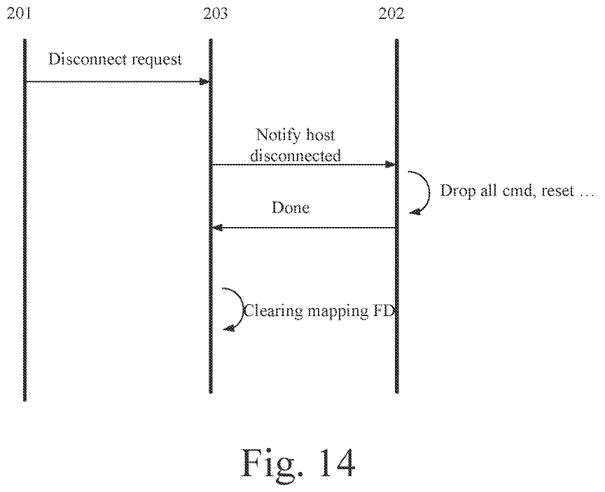

FIGS. 12 and 13 are schematic flowcharts of a computer-executed method in an example of the present disclosure. FIGS. 14 to 17 are schematic diagrams of the communication process of disconnecting a link between the first virtual machine 201 and the second virtual machine 202 in an example of the present disclosure. The communication process of disconnecting a link between the first virtual machine 201 and the second virtual machine 202 will be further described below with reference to FIGS. 12 to 17.

In some examples, as shown in FIG. 12, the method described above may further include operations S301 and S302.

Referring to FIG. 12, at operation S301, the method may include receiving a second request sent from at least one of the first virtual machine or the second virtual machine.

At operation S302, the method may include disconnecting the communication between the first virtual machine and the second virtual machine in response to the second request, wherein the second request is different from the first request.

At operation S301, the communication management module receives a second request sent from at least one of the first virtual machine or the second virtual machine.

At operation S302, the communication management module may analyze the second request sent from the first virtual machine, and send the analyzed result to the second virtual machine. The second virtual machine responds according to the received parsed result, and returns the response result to the communication management module. Thus, the communication management module may disconnect communication between the first virtual machine and the second virtual machine.

At operation S302, the communication management module may also analyze the second request sent from the second virtual machine, and send the analyzed result to the first virtual machine; the first virtual machine responds according to the received parsed result, and returns the response result to the communication management module. Thus, the communication management module may disconnect communication between the second virtual machine and the first virtual machine.

In some examples, the second request includes: a disconnect request or a timeout request.

In some examples, as shown in FIG. 13, the operation S302 described above may include operation S303.

Referring to FIG. 13, at operation S303, the method may include clearing the mapping relationship between the first virtual machine and the second virtual machine in response to the second request.

In some examples, as shown in FIG. 14, if the second request is a disconnect request and sent from the first virtual machine 201, the process may include sending a disconnect request (e.g., Disconnect request) by the first virtual machine 201. The process may include receiving, by the communication management module 20, the disconnect request. The process may include notifying the second virtual machine 202 that the first virtual machine 201 is to disconnect or has already disconnected the link (e.g., Notify host disconnected). The process may include interrupting, by the second virtual machine 202, all executed and unexecuted commands. The process may include resetting, by the second virtual machine 202, the information in the register of the second virtual machine 202 (e.g., Drop all cmd, reset). The process may include notifying, by the second virtual machine 202, the communication management module 203 that the second virtual machine 202 has been disconnected (e.g., Done). The process may include clearing, by the communication management module, the file descriptor that records the mapping relationship between the first virtual machine 201 and the second virtual machine 202 (e.g., Clearing mapping FD).

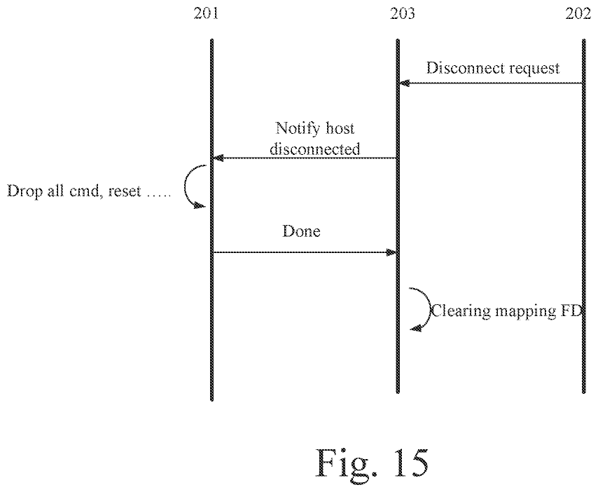

In some examples, as shown in FIG. 15, if the second request is a disconnect request and sent from the second virtual machine 202, the process may include sending, by the second virtual machine 202, a disconnect request (e.g., Disconnect request). The process may include receiving, by the communication management module 203, the disconnect request and notifying the first virtual machine 201 that the second virtual machine 202 is to disconnect or has already disconnected the link (e.g., Notify host disconnected). The process may include interrupting, by the first virtual machine 201, all executed and unexecuted commands. The process may include resetting, by the first virtual machine 201, the information in the register of the first virtual machine 201 (e.g., Drop all cmd, reset). The process may include notifying, by the first virtual machine 201, the communication management module 203, that the first virtual machine 201 has been disconnected (e.g., Done). The process may include clearing, by the communication management module, the file descriptor that records the mapping relationship between the first virtual machine 201 and the second virtual machine 202 (e.g., Clearing mapping FD).

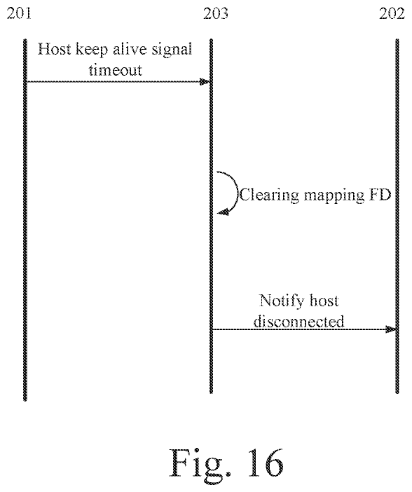

In some examples, as shown in FIG. 16, if the second request is a timeout request and sent from the first virtual machine 201, the process may include sending, by the first virtual machine 201, a timeout request to the communication management module 203 (e.g., Host keep alive signal timeout). The process may include directly clearing, by the communication management module, the file descriptor which records the mapping relationship between the first virtual machine 201 and the second virtual machine 202 (e.g., Clearing mapping FD). The process may include informing, by the communication management module, the second virtual machine 202: the first virtual machine 201 has been disconnected (e.g., Notify host disconnected).

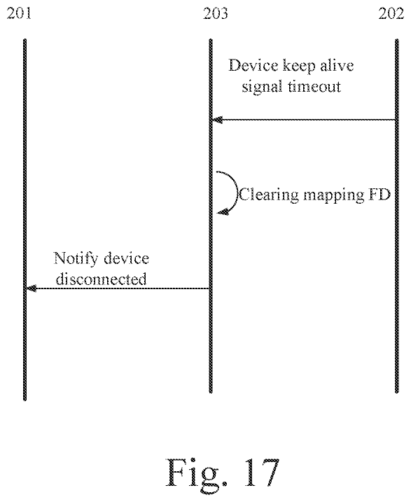

In some examples, as shown in FIG. 17, if the second request is a timeout request and sent from the second virtual machine 202, the process may include sending, by the second virtual machine 202, a timeout request to the communication management module 203 (e.g. Device keep alive signal timeout). The process may include directly clearing, by the communication management module, the file descriptor that records the mapping relationship between the first virtual machine 201 and the second virtual machine 202 (e.g., Clearing mapping FD). The process may include informing, by the communication management module, the first virtual machine 201 that the second virtual machine 202 has been disconnected (e.g., Notify device disconnected).

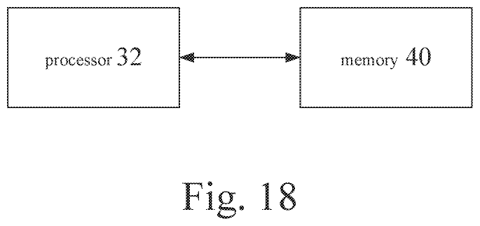

An example of the present disclosure further provides a system, as shown in FIG. 18. Referring to FIG. 18, the system may include a buffer 40 configured to store instructions. The system may include a processor 32, which is coupled to the buffer 40. The instructions, which when executed by the processor 32, may cause the processor 32 to receive a first request sent from a first virtual machine; wherein the first virtual machine is configured to emulate a host. The instructions, which when executed by the processor 32, may cause the processor 32 to establish communication between the first virtual machine and a second virtual machine in response to the first request. The second virtual machine may be configured to emulate a memory system.

Buffer 40 may include one or more computer-readable storage media, which may be non-transitory. The buffer 40 may also include static random access memory or dynamic random access memory, etc. In this example, the buffer 40 is at least used to store instructions, and the instructions may include executable codes, where the instruction, after being loaded and executed by the processor 32, may cause the processor 32 to implement the method in the examples described above. The number of buffers 40 may be one or more without limitation.

Processor 32 may include one or more processing cores, e.g., a quad-core processor, an eight-core processor, etc. The processor 32 may be implemented with at least one hardware of a Digital Signal Processing (DSP), a Field Programmable Gate Array (FPGA), a Programmable Logic Array (PLA), etc. The number of processors 32 may be one or more, and the present disclosure has no limitation to this.

In some examples, the first request may include first address information of the first virtual machine. The instructions, which when executed by the processor 32, may cause the processor 32 to send the first request to the second virtual machine. The instructions, which when executed by the processor 32, may cause the processor 32 to receive second address information sent from the second virtual machine. The second address information may be determined based on the first request. The instructions, which when executed by the processor 32, may cause the processor 32 to establish a link between the first virtual machine and the second virtual machine based on the first address information and the second address information.

In some examples, the instructions, which when executed by the processor 32, may cause the processor 32 to receive a second request sent from at least one of the first virtual machine or the second virtual machine. In some examples, the instructions, which when executed by the processor 32, may cause the processor 32 to disconnect the communication between the first virtual machine and the second virtual machine in response to the second request. The second request may be different from the first request.

In some examples, the processor includes a first processor and a second processor from different computing devices in the system. The first processor is configured to run a first development platform, and generate the first virtual machine through the first development platform. The second processor is configured to run the first development platform, and generate the second virtual machine through the first development platform.

In some examples, a system may include two or more computer devices. In the following, the system includes two computer devices for description. The first processor is from the first computer device, the second processor is from the second computer device, and a first development platform is installed on the first processor, and the first development platform includes but not limited to QEMU. The first virtual machine is generated through writing the parameter code corresponding to the host on QEMU, and the first computer device is the host of the first virtual machine. Similarly, the first development platform (e.g., QEMU) is also installed on the second processor. The second virtual machine is generated through writing the parameter code corresponding to the memory system on QEMU, and the second computer device is the host of the second virtual machine.

In some examples, the first processor or the second processor is further configured to run a second development platform, generate a communication management module, and buffer instructions corresponding to the communication management module into the buffer corresponding to the first processor or the second processor. The second development platform may be different from the first development platform.

In some examples, the buffer may further include a first buffer and a second buffer, wherein the first buffer and the first processor are located in the first computer device, and the first buffer may be used to store instructions and data related to the first processor. The second buffer and the second processor are located in the second computer device, and the second buffer may be used to store instructions and data related to the second processor.

For example, the first processor may also be configured to run a second development platform, including, but not limited to, a C-language development platform. The communication management module may be generated through compiling on the C-language development platform. At this time, instructions and data related to the communication management module may be stored in the first buffer.

As another example, the second processor may also be configured to run a second development platform, including, but not limited to, a C-language development platform. The communication management module may be generated through compiling on the C-language development platform. At this time, instructions and data related to the communication management module may be stored in the second buffer.

In some examples, the processor may be a processor of a same computing device in the system, the processor is configured to run a first development platform, and generate the first virtual machine and the second virtual machine through the first development platform.

The system may include one processor. Multiple first development platforms may run on the processor, and each development platform may generate a corresponding virtual machine. For example, two first development platforms may run, and the first virtual machine and the second virtual machine are generated through performing different compilations on each first development platform. As another example, three first development platforms may run, one of which may be compiled to generate a corresponding host, and the other two first development platforms may be compiled to generate a same or different memory systems. In an example of the present disclosure, the number of first development platforms is not limited to this.

In some examples, the processor is further configured to run a second development platform, generate a communication management module, and buffer instructions corresponding to the communication management module into the buffer. The second development platform may be different from the first development platform.

In some examples, the system includes one processor. The processor may also run a second development platform (e.g., C-language development platform), and compile on the second development platform to form a communication management module. The system also includes a buffer, which stores instructions corresponding to the communication management module. The communication management module performs the following operations through running their corresponding instructions:

The communication management module receives a first request sent from the first virtual machine, and establishes communication between the first virtual machine and the second virtual machine in response to the first request.

Since the first virtual machine and the second virtual machine emulate the host and the storage system respectively, the complex communication requirements between the host and the storage system are implemented through the communication management module, the first virtual machine and the second virtual machine. The communication process between the host and the memory system may be implemented without the interconnect layer, transport layer, and application layer. This simplifies the communication process between the host and the memory system, shorten the communication time, and increases the communication speed within a same computer device or between different computer devices.

In some examples, the first development platform may include a virtual operating system emulator.

The second development platform may include a C-language development platform.

In some examples, the system includes at least one of computer devices including: a desktop computer, a tablet computer, a laptop computer, and a server.

An example of the present disclosure further provides a computer-readable storage medium having instructions stored thereon, that when executed by a processor, may cause the processor to receive a first request sent from a first virtual machine. The first virtual machine is configured to emulate a host. The instructions, which when executed by the processor, may cause the processor to establish communication between the first virtual machine and a second virtual machine in response to the first request. The second virtual machine is configured to emulate a memory system.

Computer-readable storage media may include, but is not limited to, Random Access Memory (RAM), Read Only Memory (ROM), Electrically Erasable Programmable Read Only Memory (EEPROM), Static Random Access Memory (SRAM), hard disk, etc.

Computer-readable storage media also includes one or more of any suitable media for storage of executable instructions for a computer program, such that a machine, system, apparatus, or device may read (or retrieve) instructions from a computer-readable medium and execute instructions for performing the method.

In particular, computer-readable storage media also include flash memory. Flash memory includes general-purpose flash memory.

It should be understood that reference throughout the description to “one example” or “an example” means that a particular feature, structure or characteristic related to the example is included in at least one example of the present disclosure. Thus, appearances of “in one example” or “in an example” in various places throughout the description are not necessarily referring to a same example. Furthermore, these particular features, structures or characteristics may be combined in any appropriate manner in one or more examples. It should be understood that in various examples of the present disclosure, sequence numbers of the processes described above do not mean the execution order, and the execution order of each process should be determined by its function and internal logic, and should not constitute any limitation to implementation process of examples of the present disclosure. The serial numbers of examples of the present disclosure described above are for the purpose of description only, and do not represent the advantages and disadvantages of the examples.

It should be noted that, in this description, the terms “including”, “containing” or any other variations thereof are intended to cover a non-exclusive inclusion, such that a process, method, article or device that includes a series of elements includes not only those elements but also other elements not expressly listed or that are inherent to the process, method, article or device. Without further limitation, an element defined by the statement “including a . . . ” does not exclude the presence of additional identical elements in a process, method, article, or device that includes that element.

The above is only implementations of the present disclosure, but the claimed scope of the present disclosure is not limited thereto, and changes or substitutions within the technical scope disclosed in the present disclosure that may be easily conceived by those skilled in the art shall fall within the claimed scope of the present disclosure.

What is claimed is:

1. A computer-executed method, comprising:
receiving a first request sent from a first virtual machine, the first virtual machine being configured to emulate a host; and
establishing communication between the first virtual machine and a second virtual machine in response to the first request, the second virtual machine being configured to emulate a memory system.

2. The method of claim 1, wherein:
the first request includes first address information of the first virtual machine, and
the establishing communication between the first virtual machine and a second virtual machine in response to the first request comprises:
sending the first request to the second virtual machine;
receiving second address information sent from the second virtual machine, the second address information is determined based on the first request; and
establishing a link between the first virtual machine and the second virtual machine based on the first address information and the second address information.

3. The method of claim 2, wherein the establishing communication between the first virtual machine and a second virtual machine in response to the first request further comprises:
establishing a mapping relationship between the first virtual machine and the second virtual machine based on the first address information and the second address information.

4. The method of claim 2, wherein:
the first request further includes an operation command, and
the establishing communication between the first virtual machine and a second virtual machine in response to the first request further comprises:
sending data information sent from the first virtual machine to the second virtual machine in response to the operation command; or
sending the data information sent from the second virtual machine to the first virtual machine in response to the operation command.

5. The method of claim 4, further comprising:
buffering the data information.

6. The method of claim 1, further comprising:
receiving a second request sent from at least one of the first virtual machine or the second virtual machine; and
disconnecting the communication between the first virtual machine and the second virtual machine in response to the second request, the second request being different from the first request.

7. The method of claim 6, wherein the disconnecting the communication between the first virtual machine and a second virtual machine in response to the second request comprising:
clearing a mapping relationship between the first virtual machine and the second virtual machine in response to the second request.

8. The method of claim 6, wherein the second request includes a disconnect request or a timeout request.

9. The method of claim 1, wherein:
the first virtual machine and the second virtual machine are generated by a same computer device, and
a manner for the communication between the first virtual machine and the second virtual machine includes inter-process communication.

10. The method of claim 1, wherein:
the first virtual machine and the second virtual machine are generated by different computer devices, and
a manner for the communication between the first virtual machine and the second virtual machine includes network communication.

11. The method of claim 1, wherein the memory system comprises Universal Flash Storage.

12. A system, comprising:
a processor; and
a buffer storing instructions, which when executed by the processor, cause the processor to:
receive a first request sent from a first virtual machine, the first virtual machine may be configured to emulate a host; and
establish communication between the first virtual machine and a second virtual machine in response to the first request, the second virtual machine being configured to emulate a memory system.

13. The system of claim 12, wherein:
the first request includes first address information of the first virtual machine, and
the buffer storing instructions, which when executed by the processor, further cause the processor to:
send the first request to the second virtual machine;
receive second address information sent from the second virtual machine, the second address information being determined based on the first request; and
establish a link between the first virtual machine and the second virtual machine based on the first address information and the second address information.

14. The system of claim 12, wherein the buffer storing instructions, which when executed by the processor, further cause the processor to:
receive a second request sent from at least one of the first virtual machine or the second virtual machine; and
disconnect the communication between the first virtual machine and the second virtual machine in response to the second request, the second request being different from the first request.

15. The system of claim 12, wherein:
the processor includes a first processor and a second processor from different computing devices in the system,
the buffer storing instructions, which when executed by the first processor, cause the first processor to run a first development platform, and to generate the first virtual machine through the first development platform; and
the buffer storing instructions, which when executed by the second processor, cause the second processor to run the first development platform, and to generate the second virtual machine through the first development platform.

16. The system of claim 15, wherein the buffer storing instructions, which when executed by the first processor or the second processor, cause the first processor or the second processor to:
run a second development platform;
generate a communication management module; and
buffer instructions corresponding to the communication management module into the buffer, the second development platform being different from the first development platform.

17. The system of claim 12, wherein:
the processor comprises a processor of a same computing device in the system, and
the buffer storing instructions, which when executed by the processor, cause the processor to:
run a first development platform, and
generate the first virtual machine and the second virtual machine through the first development platform.

18. The system of claim 17, wherein the buffer storing instructions, which when executed by the processor, cause the processor to:
run a second development platform,
generate a communication management module, and
buffer instructions corresponding to the communication management module into the buffer, the second development platform being different from the first development platform.

19. The system of claim 18, wherein:
the first development platform includes: a virtual operating system emulator, and
the second development platform includes a C-language development platform.

20. A non-transitory computer-readable storage medium having instructions stored thereon, which when executed by a processor, cause the processor to:
receive a first request sent from a first virtual machine, the first virtual machine being configured to emulate a host; and
establish communication between the first virtual machine and a second virtual machine in response to the first request, the second virtual machine being configured to emulate a memory system.
